(19) United States
(12) Patent Application Publication
(10) Pub. No.: US 2012/0117834 A1
(43) Pub. Date: May 17, 2012

(54) ILLUMINATED POWERED DEVICES SUCH AS CARDS AND METHODS OF USE

(75) Inventors: Daniel J. TILLWICK, St. Petersburg, FL (US); David B. COREY, Tampa, FL (US); David EAGLESON, Severna Park, MD (US)

(73) Assignee: SOLICORE, INC., Lakeland, FL (US)

(21) Appl. No.: 13/284,443

(22) Filed: Oct. 28, 2011

Related U.S. Application Data
(60) Provisional application No. 61/414,255, filed on Nov. 16, 2010.

(51) Int. Cl. G09F 1/00

(52) U.S. Cl. 40/124.02

(57) ABSTRACT

Compact powered devices are provided. The powered devices include a substrate, a battery, an activation element and an output device in electrical or optical communication. The compact powered device can be a card that, when subjected to an outside influence or stimulus, displays a message or illumination. The illumination can be circumscribed within a graphical design of the card. The card can be a gift card, a loyalty card, a novelty card, a financial card, an identification card or a smart card. The output device can be a light guide film that distributes light from an illumination device such as an LED which, when activated, illuminates a side of the light guide film. The output device is configured to display a number, a graphic, a logo, or another pattern or message in response to the stimulus.

### BACKGROUND

1. Field

The present invention relates generally to powered devices and, more particularly, to active, powered devices in card form that can be activated by a consumer thereby displaying information and/or illumination.

2. Background of the Technology

Advertisers and retailers continually search for new and effective ways to capture the interest of consumers. Through advertising mediums, consumers are constantly bombarded with advertisements and brand messaging, each competing for the consumer's attention. Thus, there remains a need for methods and devices that draw the attention of consumers or otherwise enhance the effect of a brand or advertising message. Moreover, in meeting these needs, advertisers and retailers prefer inexpensive and versatile devices that are compact and can be easily displayed in a retail or point of sale (POS) setting or even displayed or animated on a web page banner.

Advertisers and retailers prefer brand messaging and advertisements that form, in a consumer's mind, a strong connection between an advertisement and its associated product and/or brand, and draw the consumer to purchase the product or other company related products.

With regard to novelty/gift cards, product companies and retailers desire effective ways of capturing the interest of consumers in retail locations or Internet portals. For example, product companies often provide special displays, bins, kiosks, and other freestanding point-of-purchase display devices or web banners or advertisements to draw attention to their products. If their products are displayed on a shelf alone or hanging on a stand with other competing products, the maker of the product must rely on the design of the product or packaging to make their products stand out. To that end, product companies and retailers have typically favored bright, eye-catching graphics and specially shaped packages (e.g., other than box-shaped) that include ancillary products or product offers. A common example of such packaging is a cereal box that includes and displays promotional items, such as music and software CDs or miniature toys. These additional items can, however, add an undesirable level of complexity to the cost, manufacturing and handling of the packaging. There are also benefits to having the package conform to standard size for shelf space, while still attracting the attention of the consumer.

Thus, there remains a need for methods and devices that attract the attention of shoppers or otherwise enhance the effect of a product or product package. Moreover, in meeting these needs, manufacturers and retailers prefer inexpensive and versatile devices that are compact and can be easily incorporated into existing display infrastructure without disrupting the normal distribution or display processes.

### SUMMARY

A powered device is provided which comprises:

a substrate;

a battery in or on the substrate;

an activation element in or on the substrate and in electrical communication with the battery; and

an output device in or on the substrate and in electrical and/or optical communication with the battery and the activation element, wherein the output device comprises a light-guide film;

wherein the activation element activates the output device in response to a stimulus and the output device outputs a message and/or illumination upon activation.

A method is also provided which comprises:

providing a powered device as set forth above; and

applying a stimulus to the activation element of the powered device to activate the output device, wherein the output device produces illumination or outputs a message upon activation.

These and other features of the present teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a picture of the back of a powered device showing electrical circuitry, an LED and a light guide film (LGF), wherein the device is shown prior to encapsulation into a plastic (e.g., PVC) substrate to form a powered card.

FIG. 2 is picture of the back of the powered device of FIG. 1 prior to encapsulation wherein the device is shown with the LED activated thereby displaying the illumination properties of the device.

FIG. 3 is a picture of the powered device of FIG. 1 showing the front of the device prior to printing.

FIG. 4 is a picture of the powered device of FIG. 1 showing the front of the device after printing to produce a powered gift card.

### DESCRIPTION OF THE VARIOUS EMBODIMENTS

Powered devices such that can be activated by a consumer thereby displaying information are described. The information may be a number, a graphic, a logo or other branding information, a marketing message or any other message and/or picture. The information may be displayed by activating a distributed light guide film (LGF). The device can be a powered card. Exemplary and non-limiting embodiments of powered cards include novelty cards, gift cards, loyalty cards, financial cards, identification cards and smart cards.

A powered device is provided which comprises a thin, flexible substrate (typically plastic or PVC). The substrate may have printed material thereon. The powered device comprises a battery in or on the substrate and an activation element in or on the substrate and in electrical communication with the battery. The device also comprises an output device in or on the substrate and in electrical and/or optical communication with the battery and the activation element. The battery, the activation element, and the output device are connected such that the substrate, the battery, the activation element, and the output device substantially maintain the thin and flexible qualities of the substrate. The activation element activates the output device in response to a stimulus. The activation element can be a button and the stimulus can be a press or tap. Other types of activation elements can be used including, but not limited to, snap switches. Exemplary and non-limiting embodiments of stimuli that can be used include light, motion, disruption, bending and micro-currents. Alternatively, the card can be always activated (i.e., always on). The output device can comprise a light source and a light guide film (LGF).

According to some embodiments, the output device is a light guide film (LGF). The light guide film can be a thin transparent material (e.g., polycarbonate) that contains specific areas (e.g., on a surface thereof) that are disturbed (e.g., etched) thereby catching and dispersing light passing through the film (e.g., by a side firing light emitting diode (LED) or other miniature illumination device). The light reflecting off of the disturbed areas is thereby projected upward and outward. The areas of the light guided film that are not disturbed allow the light to pass though the film without being dispersed. Accordingly, only the area or areas that are disturbed on the light guide film produce light visible on the surface of the film. The light guide film thereby provides the characteristics of backlighting but with only one source of light. The light guide film can be circumscribed within the graphical design of the device.

The light guide film, circuit, battery and illumination device (e.g., LED) can be encapsulated into a credit card sized form factor. In particular, the powered device can have a size of 85.60×53.98 mm (3.370×2.125 in) and having a thickness range based on the international standard specifications of ISO/IEC 7813 of 0.76 mm (with an allowable deviation between 0.64 mm and 0.84 mm) and having corners rounded with a radius of 3.18 mm. The resulting device can be a novelty card or a gift card. This card can be illuminated upon activation by the consumer. Alternatively, the device can be in an illuminated state prior to receipt by the consumer.

According to further embodiments, a method of communicating an advertising or brand message, logo, character or any other information is provided in which a thin, flexible electronic display device is powered with a battery, and the battery is disposed or build into in the electronic display device and maintains a substantially planar credit card like form, but can be any size. The electronic display device comprises an activation element and an output device and the activation element is subjected to a stimulus created by a consumer or other means. The output device is activated in response to the stimulus and, when activated, can produce an illuminated effect highlighting the advertising or brand message to the consumer by illuminating that message, logo or other character or number.

In accordance with the present invention, various embodiments of a powered device are provided. The powered device can include circuitry and circuitry elements that can be embedded or otherwise disposed on or in a thin and flexible substrate. The powered device can be provided in a compact and convenient form. According to some embodiments, the powered device is a card such as a gift card, a novelty card, a loyalty card, a financial card, an identification card or a smart card. The powered device can be thin enough to fit into a consumer's wallet or billfold and can have dimensions similar to those of a standard credit card. For example, the powered device may have the same thickness as that of a standard credit card (e.g., about 30 mils or about 0.76 mm thick or less). For example, the card can have the dimensions of an ID-1 format card size of 85.60×53.98 mm (3.370×2.125 in) and a thickness range based on the international standard specifications of ISO/IEC 7813 of 0.76 mm (with an allowable deviation between 0.64 mm and 0.84 mm) and having corners rounded with a radius of 3.18 mm.) The powered device, however, may be thicker to accommodate a thicker circuit, battery or activation device.

According to some embodiments, a powered illuminated gift card is provided. The powered gift card can comprise a thin, flexible substrate (e.g., PVC, PET plastic or paper) having an embedded battery and electrical circuitry. When powered by the battery, the circuitry can, for example, display a light array, alphanumeric characters or graphics. The powered illuminated gift card can be used on a point of sale (POS) display or animated via a web banner or internet advertisement. The battery and circuitry can be incorporated directly into the substrate of the gift card.

The electrical circuitry can be activated by any suitable means including, but not limited to, button, light, motion, disruption, bending, micro-currents or a snap-switch. For example, the circuitry can be activated by activation elements that respond to contactless stimuli, such as light sensors, audio sensors, motion sensors or detectors. Alternatively, the circuitry can be activated by activation elements that respond to stimuli that make contact with the element or a portion of the element, such as mechanical switches, buttons or taps. With light, audio, and motion sensors, the illuminated gift card can be activated when the appropriate stimulus is received. With mechanical switches, the illuminated gift card can be, for example, activated by pressing a button or multiple buttons. In some applications, a user-actuated mechanical switch may be preferred to save power and extend the shelf life of the gift card. Once activated, the powered advertisement can produce lights and displays that are incorporated into the graphic design of the illuminated powered gift card.

According to some embodiments, the circuitry and battery are encapsulated in a polymer such as polyvinyl chloride (PVC) or sealed between multiple layers of polymer to form the powered device. The powered device may meet at least the flexibility requirements of the international standard specifications of ISO/IEC 7810:2003, but is not required to do so.

The powered device may comprise a thin-film battery. One example of an appropriate battery for the powered device is available from Solicore, Inc., Lakeland, Fla. The battery may comprise a polymer matrix electrolyte (PME). The battery can be ultra-thin (e.g., approximately 0.3 mm) and flexible, environmentally friendly and safe. The device may also comprise any other form factor battery, including but not limited to a coin cell battery.

According to some embodiments, the batteries can possess one or more of the following characteristics:

low profile design—approximately 0.3 mm thick;

flexible and will not break or crack when bent or flexed;

conformable, in that the electrolyte can be a solid, non-compressible film, which can be shaped and formed into a variety of designs;

compatible with high speed printing and binding processes, and card manufacturing processes, and capable of surviving hot lamination processes;

operable over a wide temperature range (−20° C. to +60° C.);

offer high ionic conductivity over a broad temperature range;

possess a low self discharge rates (e.g., less than 1% per month);

provide high energy density (e.g., up to 300 Wh/l), thus offering maximum performance in smallest packages;

possess self connecting terminals;

are non-toxic, disposable, and environmentally friendly;

contain solid polymer electrolyte e.g., contain no volatile liquids or gelling agents);

offer overall safety with no out-gassing, swelling, or thermal runaway;

require no need for added safety devices;

pass UL requirements for crush test, drop test, and nail test; and

inherently safe thus reducing the need for additional battery safety circuitry.

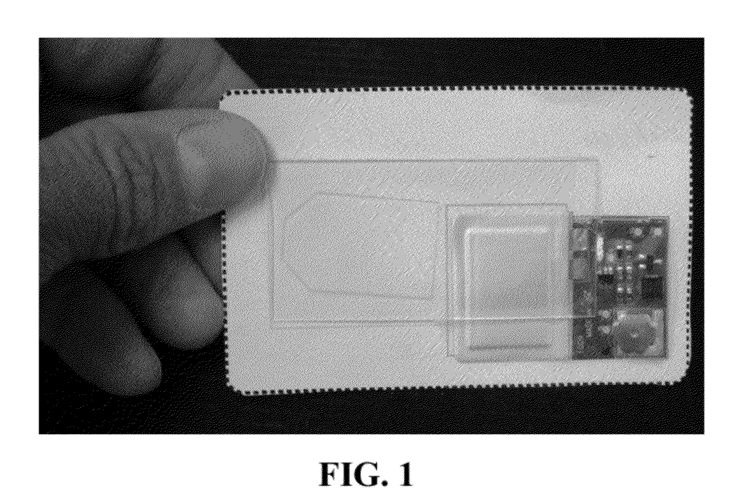

FIG. 1 is a picture of the back of a powered device showing electrical circuitry, an LED and a light guide film (LGF), wherein the device is shown prior to encapsulation into a plastic (e.g., PVC) substrate to form a powered card. As shown in FIG. 1, a thin film battery is shown in electrical communication with an activation element (i.e., a button) via circuitry. A light guide film and an illumination device (i.e., an LED or light emitting diode) are also shown.

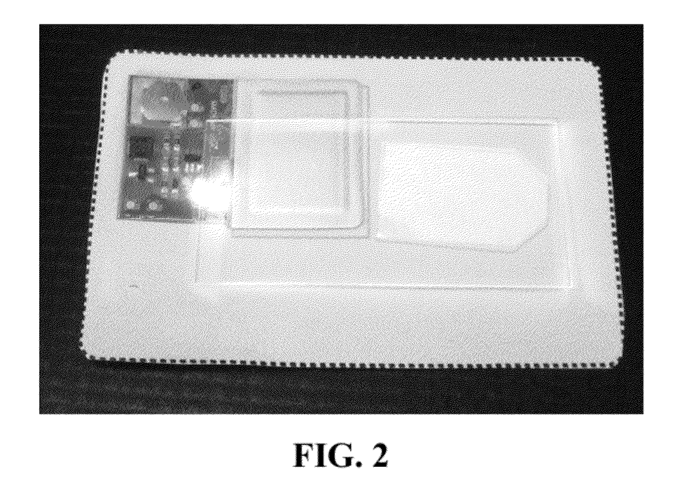

FIG. 2 is picture of the back of the powered device of FIG. 1 prior to encapsulation wherein the device is shown with the LED activated thereby displaying the illumination properties of the device. As shown in FIG. 2, a portion of the light guide film (LGF) is disturbed (e.g., via etching) and thereby illuminated by the side firing LED. In contrast, as shown in FIG. 2 non-disturbed portions of the LGF are not illuminated.

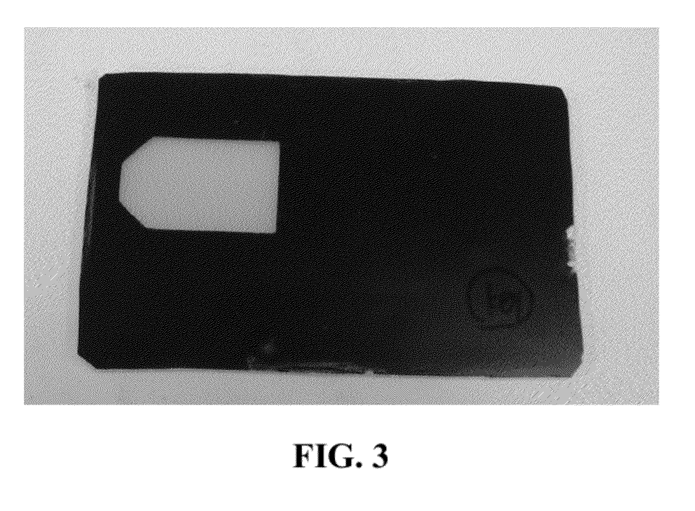

FIG. 3 is a picture of the powered device of FIG. 1 showing the front of the device prior to printing and encapsulation. As shown in FIG. 3, a window is provided allowing light from the disturbed portions of the LGF to be observed on the front surface of the card when the LGF is activated.

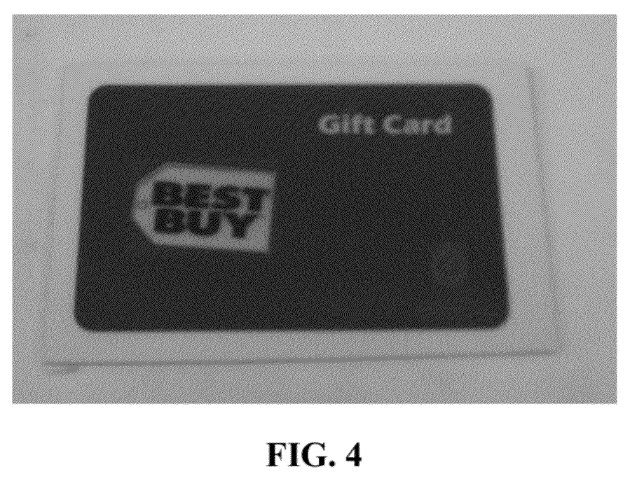

FIG. 4 is a picture of the powered device showing the front of the device after printing and encapsulation to produce a powered gift card.

According to some embodiments, the circuit and/or the battery in the powered device meet at least the mechanical flexibility requirements of the international standard specifications of ISO/IEC 7810:2003. According to some embodiments, the powered device comprising the battery and the circuitry meets at least the mechanical flexibility requirements of the international standard specifications of ISO/IEC 7810:2003.

According to some embodiments, the powered device has dimensions of 80-90 mm long, 50-60 mm wide and 0.5 to 1.5 mm thick. According to some embodiments, the powered device has a thickness of 1.5 mm or less. Specifically, that of the range of ID-1 format card size of 85.60×53.98 mm (3.370×2.125 in) and having an allowable thickness range based on the international standard specifications of ISO/IEC 7813 of 0.76 mm (with an allowable deviation between 0.64 mm and 0.84 mm) and having corners rounded with a radius of 3.18 mm.

According to some embodiments, the powered device meets at least the mechanical flexibility requirements of the international standard specifications of ISO/IEC 7810:2003. Moreover, the powered device will work correctly and will not have any cracks after being flexed 1000 times along the short and/or long dimension as specified below:

for flexing in the long dimension (e.g., along the 80-90 mm length), a deformation of 2 cm at a periodicity of 30 bends a minute; and

for flexing in the short dimension (e.g., along the 50-60 mm width), a deformation of 1 cm at a periodicity of 30 bends a minute.

While the foregoing specification teaches the principles of the present invention, with examples provided for the purpose of illustration, it will be appreciated by one skilled in the art from reading this disclosure that various changes in form and detail can be made without departing from the true scope of the invention.

What is claimed is:

1. A powered device comprising:
a substrate;
a battery in or on the substrate;
an activation element in or on the substrate and in electrical communication with the battery; and
an output device in or on the substrate and in electrical and/or optical communication with the battery and the activation element, wherein the output device comprises a light-guide film;
wherein the activation element activates the output device in response to a stimulus and the output device outputs a message and/or illumination upon activation.

2. The powered device of claim 1, wherein the output device further comprises an illumination device which, when activated, illuminates a side of the light guide film.

3. The powered device of claim 1, wherein the powered device meets at least the mechanical flexibility requirements of the international standard specifications of ISO/IEC 7810:2003.

4. The powered device of claim 1, wherein the powered device is card selected from the group consisting of a gift card, a loyalty card, a novelty card, a financial card, an identification card and a smart card.

5. The powered device of claim 4, wherein the output of the output device comprises information related to the card.

6. The powered device of claim 1, wherein the activation element is a motion sensor, a remote control sensor, an accelerometer or a touch sensitive sensor.

7. The powered device of claim 1, wherein the activation element is a capacitive touch sensitive sensor, a resistive touch sensitive sensor or a combination capacitive and resistive touch sensitive sensor.

8. The powered device of claim 1, wherein the substrate comprises printed material thereon.

9. The powered device of claim 1, wherein an image is illuminated in the light-guide film when activated.

10. The powered device of claim 1, wherein the substrate is a polymer.

11. The powered device of claim 10, wherein the substrate is selected from the group consisting of polyvinyl chloride (PVC), polyethylene terephthalate (PET), plastic and paper.

12. The powered device of claim 1, wherein the powered device is 80-90 mm long, 50-60 mm wide and 0.5 to 1.5 mm thick.

13. The powered device of claim 1, wherein the battery is a thin film battery.

14. The powered device of claim 13, wherein the battery is 0.3+/−0.05 mm thick

15. The powered device of claim 13, wherein the battery comprises a polymer matrix electrolyte (PME).

16. The powered device of claim 1, further comprising a circuit on or in the substrate.

17. The powered device of claim 15, wherein the powered device meets at least the mechanical flexibility requirements of the international standard specifications of ISO/IEC 7810:2003.

18. The powered device of claim 3, wherein the powered device has dimensions of 85.60×53.98 mm and a thickness of 0.64 mm to 0.84 mm and corners rounded with a radius of 3.18 mm.

19. A method comprising:
providing a powered device according to claim 1; and
applying a stimulus to the activation element of the powered device to activate the output device, wherein the output device produces illumination or outputs a message upon activation.

20. The method of claim 19, wherein the stimulus is applied by a consumer and wherein the output device outputs an advertizing message and/or illumination to the consumer.

21. The method of claim 19, wherein the output device produces illumination upon activation and wherein the illumination is circumscribed within a graphical design on the card.

22. The method of claim 19, wherein the stimulus is light, motion, disruption, bending, micro-currents or touch.
